(19) United States
(12) Patent Application Publication
(10) Pub. No.: US 2024/0077581 A1
(43) Pub. Date: Mar. 7, 2024

(54) HIGH-RESOLUTION ANTENNA ARRAY

(71) Applicant: CUBTEK INC., Zhubei City (TW)

(72) Inventors: HONG-LUN CHEN, Zhubei City (TW); YU-WANG HU, Zhubei City (TW)

(73) Assignee: CUBTEK INC., Zhubei City (TW)

(21) Appl. No.: 18/085,345

(22) Filed: Dec. 20, 2022

(30) Foreign Application Priority Data
Sep. 1, 2022 (TW) 111133104

(51) Int. Cl. G01S 7/40; G01S 13/08; H01Q 21/06

(52) U.S. Cl. CPC G01S 7/4004; G01S 13/08; H01Q 21/061; G01S 2013/0245

(57) ABSTRACT

A high-resolution antenna array includes an equivalent antenna array obtained by arrangement of a first and a second physical antenna array. The equivalent antenna array includes a first and a second equivalent antenna group respectively having a plurality of first and second antenna units arranged at equal intervals. The second equivalent antenna group is translated by a unit interval with respect to the first equivalent antenna group, such that each first and second antenna units are staggered and arranged at intervals along a same direction. A processor obtains a target signal reflected by a target object and carries out a calibration on the target signal to obtain a precise phase difference, thereby obtaining an accurate angle of arrival of the target signal. Thus, through the distribution of antennas, the present invention achieves a high angle resolution and prevents angle ambiguity.

### BACKGROUND OF THE INVENTION

### 1. Field of the Invention

The present invention relates to antennas, and more particularly, to a high-resolution antenna array system.

### 2. Description of the Related Art

Regarding technology nowadays, using radar to detect the position of an object to facilitate the confirmation of the target object has become an important development technology. The development of radar technology accelerates the maturity of, for example, the automatic driving technology of automobiles. A radar detects an object through an antenna. The uniform linear array (ULA) and the sparse linear array (SLA) are both common antenna arrangement characteristics. When a limited number of antennas are applied for multi-target detection, in the circumstance using the SLA arrangement, the signal superposition of the side lobe often causes a strength which is closed to that of the reflection signal of the main lobe, resulting in more than one target detection angle and leading to an erroneous detection. Generally, the ULA arrangement is used, so as to prevent the signal superposition of the side lobe through the low side lobe characteristic of ULA arrangement.

In order to fulfill the condition of high-angle resolution of the antenna at the same time, with a limited number of antenna units, the ULA arrangement increases the length of the antenna array by increasing the interval distance between the antenna units, so as to adjust the aperture of the antenna array, thereby increasing the resolution of the antenna angle. However, the antenna interval of the ULA arrangement will be greater than half a wavelength and reduce the resolvable angle range, causing an angle ambiguity of the radar in the detection of the angle of the target object, failing to accurately judge the angle of arrival (AoA) of the target object.

### SUMMARY OF THE INVENTION

The present invention discloses a high-resolution antenna array system. With the distribution design of the antenna array, the present invention facilitates a high angular resolution and prevents angle ambiguity.

For achieving the aforementioned objectives, an embodiment in accordance with the present invention provides a high-resolution antenna array system for detecting the angle and distance of at least one target object, the antenna array system comprising a first physical antenna array, a second physical antenna array, an equivalent antenna array, and a processor. The first physical antenna array comprises at least one first physical antenna. The second physical antenna array comprises a plurality of second physical antennas. The first and second physical antenna arrays are configured to detect the target object and carry out transmission and receiving of signal. The equivalent antenna array is obtained by multiplying the positions of the first physical antenna array by the positions of the second antenna array. The equivalent antenna array comprises a first equivalent antenna group having a plurality of first antenna units arranged at equal intervals and a second equivalent antenna group having a plurality of second antenna units arranged at equal intervals, wherein the second equivalent antenna group is translated by a unit interval with respect to the first equivalent antenna group, such that each first antenna unit and each second antenna unit are staggered and arranged at intervals along the same direction. The interval between each two neighboring first antenna units and the interval between each two neighboring second antenna units are N times the unit interval, wherein N is a positive integer, and N is larger than or equal to (≥) 3. The processor is coupled with the first physical antenna array and the second physical antenna array, through which the processor obtains a target signal reflected by the target object. The target signal comprises a first frequency spectrum information from the first equivalent antenna group, and a second frequency spectrum information from the second equivalent antenna group. The processor carries out a calibration according to the first frequency spectrum information and the second frequency spectrum information and obtains a precise phase difference, thereby obtaining an accurate angle of arrival of the target signal through the precise phase difference.

Another embodiment in accordance with the present invention provides a high-resolution antenna array system for detecting the angle and the distance of at least one target object, the antenna array system comprising a first physical antenna array, a second physical antenna array, and a processor. The first physical antenna array comprises a first antenna and a second antenna. The interval between the first antenna and the second antenna is 2N times a unit interval, wherein N is a positive integer, and N is larger than or equal to 3. The second physical antenna array comprises a third antenna, a fourth antenna, a fifth antenna, and a sixth antenna orderly arranged along the same direction. The interval between the third antenna and the fourth antenna is the unit interval, the interval between the fourth antenna and the fifth antenna is (N-1) times the unit interval, and the interval between the fifth antenna and the sixth antenna is the unit interval, wherein the first physical antenna array and the second physical antenna array are configured to detect the target object, carry out transmission and receiving of signal, and obtain a target signal from the target object. The processor is coupled with the first physical antenna array and the second physical antenna array, through which the processor obtains the target signal. Therein, the processor processes the target signal to generate a first frequency spectrum information and a second frequency spectrum information and carries out a calculation with the first and the second frequency spectrum information to generate a precise phase difference, so as to obtain an accurate angle of arrival of the target signal through the precise phase difference.

Another embodiment in accordance with the present invention provides a high-resolution antenna array system for detecting the angle and the distance of at least one target object, the antenna array system comprising a first physical antenna array, a second physical antenna array, and a processor. The first physical antenna array comprises a first antenna and a second antenna. The interval between the first antenna and the second antenna is a unit interval. The second physical antenna array comprises a third antenna, a fourth antenna, a fifth antenna, and a sixth antenna orderly arranged at equal intervals along the same direction. The interval between the third antenna, the fourth antenna, the fifth antenna, and the sixth antenna are N times the unit interval, wherein N is a positive integer, and N is larger than or equal to 3. Therein, the first physical antenna array and the second physical antenna array are configured to detect the target object, carry out transmission and receiving of signal, and obtain a target signal from the target object. The processor is coupled with the first physical antenna array and the second physical antenna array, through which the processor obtains the target signal. Therein, the processor processes the target signal to generate a first frequency spectrum information and a second frequency spectrum information and carries out a calculation with the first and the second frequency spectrum information to generate a precise phase difference, so as to obtain an accurate angle of arrival of the target signal through the precise phase difference.

Another embodiment in accordance with the present invention provides a high-resolution antenna array system for detecting the angle and the distance of at least one target object, the antenna array system comprising a first physical antenna array, a second physical antenna array, and a processor. The first physical antenna array comprises a first antenna and a second antenna. The interval between the first antenna and the second antenna is N times of a unit interval, wherein N is a positive integer, and N is larger than or equal to 3. The second physical antenna array comprises a third antenna, a fourth antenna, a fifth antenna, and a sixth antenna orderly arranged along the same direction. The interval between the third antenna and the fourth antenna is the unit interval, the interval between the fourth antenna and the fifth antenna is (2N-1) times the unit interval, and the interval between the fifth antenna and the sixth antenna is the unit interval. Therein, the first physical antenna array and the second physical antenna array are configured to detect the target object, carry out transmission and receiving of signal, and obtain a target signal from the target object. The processor is coupled with the first physical antenna array and the second physical antenna array, through which the processor obtains the target signal. Therein, the processor processes the target signal to generate a first frequency spectrum information and a second frequency spectrum information and carries out a calculation with the first and the second frequency spectrum information to generate a precise phase difference, so as to obtain an accurate angle of arrival of the target signal through the precise phase difference.

With such configuration, the high-resolution antenna array system, through the equivalent antenna array obtained from the distribution design of the first physical antenna array and the second physical antenna array, is able to increase the length of the antenna array under the condition of a limited number of the antenna units, so as to increase the aperture of the antenna array, thereby increasing the angle resolution of antenna.

Further, with the precise phase difference generated by the processor calculating the first frequency spectrum information and the second frequency spectrum information from the equivalent antenna array, the present invention prevents the angle ambiguity and obtains the accurate angle of arrival of the target signal.

### BRIEF DESCRIPTION OF THE DRAWINGS

FIG. 1 is a structural block view of the high-resolution antenna array system of the present invention.

FIG. 2 is a schematic view of the physical antenna array in accordance with the first embodiment of the present invention.

FIG. 3 is a schematic view of the equivalent antenna array of the present invention.

FIG. 4 is a frequency spectrum diagram of the first and second equivalent antenna groups.

FIG. 5 is a schematic view of the physical antenna array in accordance with the second embodiment of the present invention.

FIG. 6 is a schematic view of the physical antenna array in accordance with the third embodiment of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

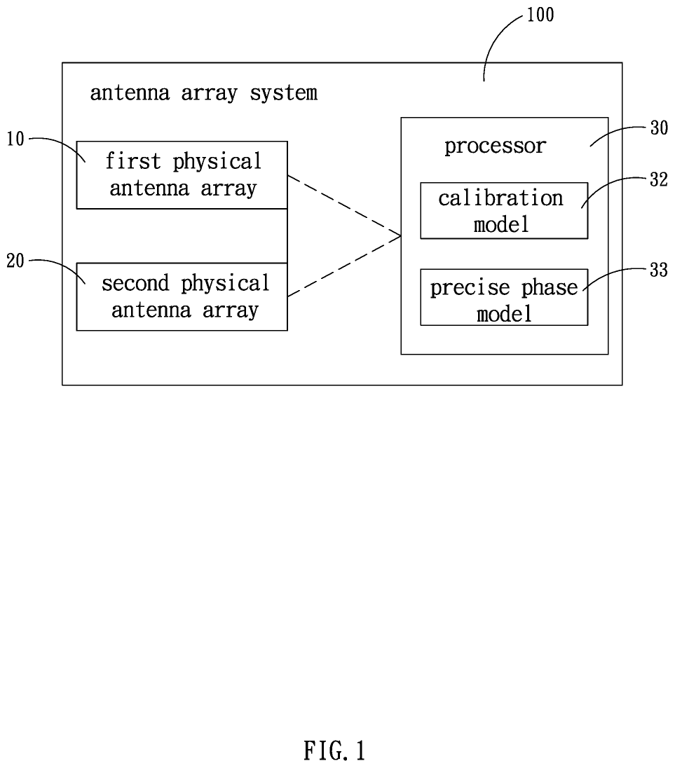

Referring to FIG. 1 to FIG. 6, the present invention provides a high-resolution antenna array system 100 for detecting the angle and distance of at least one target object. The antenna array system 100 comprises a first physical antenna array 10, a second physical antenna array 20, a processor 30, and an equivalent antenna array 40. The processor 30 is coupled with the first physical antenna array 10 and the second physical antenna array 20. The equivalent antenna array 40, in the present invention, is obtained by multiplying the positions of the first physical antenna array 10 by the positions of the second physical antenna array 20, which will be illustrated in the following content.

The first physical antenna array 10 comprises at least one first physical antenna, and the second physical antenna array 20 comprises a plurality of second physical antennas. The first physical antenna array 10 and the second physical antenna array 20 are configured to detect the target object and carry out the transmission and receiving of signal.

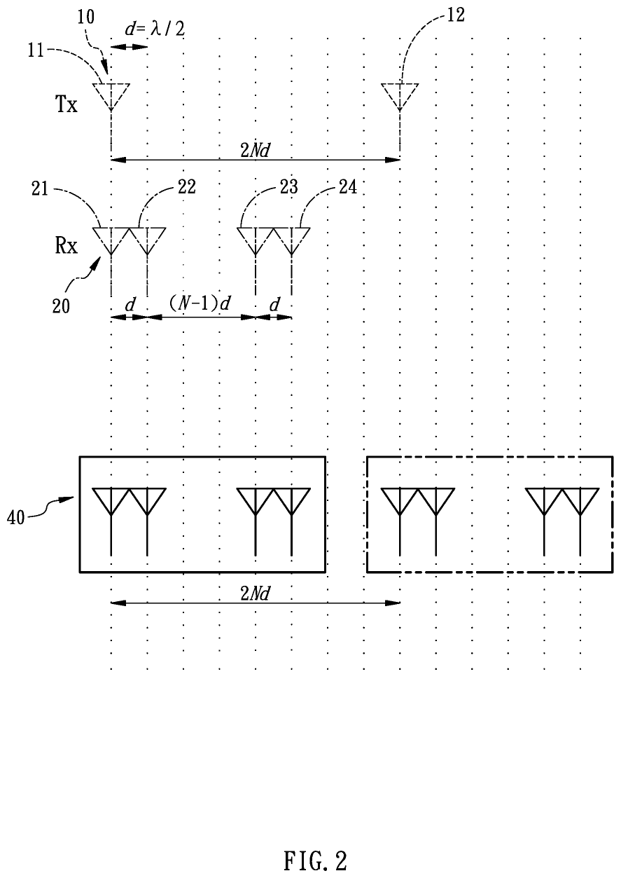

Referring to FIG. 2, the schematic view of the physical antenna array in accordance with the first embodiment of the present invention is shown. In the embodiment, the first physical antenna array 10 comprises a first antenna 11 and a second antenna 12. The second physical antenna array 20 comprises a third antenna 21, a fourth antenna 22, a fifth antenna 23, and a sixth antenna 24 orderly arranged along the same direction.

The interval between the first antenna 11 and the second antenna 12 is 2N times a unit interval d. The interval between the third antenna 21 and the fourth antenna 22 is the unit interval d. The interval between the fourth antenna 22 and the fifth antenna 23 is (N-1) times the unit interval d. The interval between the fifth antenna 23 and the sixth antenna 24 is the unit interval d. Therein, the unit interval d is larger than or equal to (≥) ½λ, and λ is the wavelength of the transmission signal. N is a positive integer, and N is larger than or equal to 3. In the embodiment, N is equal to 4.

In the embodiment, the first physical antenna array 10 is the transmission antenna, and the second physical antenna array 20 is the receiving antenna. However, the configuration is allowed to be exchanged, such that the first physical antenna array 10 is the receiving antenna, and the second physical antenna array 20 is the transmission antenna. In the embodiment, the equivalent antenna array 40 is allowed to be a physical antenna or a combination of a physical antenna and a virtual antenna. Also, the first physical antenna array 10 is allowed to be extended multiple times at equal intervals, so as to include four antennas or six antennas, etc. Similarly, the second physical antenna array 20 is allowed to be extended multiple times at equal intervals, so as to include eight antennas or twelve antennas, etc.

Further, according to the description above, the equivalent antenna array 40 in the present invention is obtained by multiplication and combination of the positions of the first physical antenna array 10 and the second physical antenna array 20. Taking the embodiment as an example, regarding the formation of the equivalent antenna array 40, the first antenna 11 is multiplied by the third antenna 21, the fourth antenna 22, the fifth antenna 23, and the sixth antenna 24, so as to generate an array whose positions and distributions are identical to that of the third antenna 21, the fourth antenna 22, the fifth antenna 23, and the sixth antenna 24. Then, the second antenna 12 is multiplied by the third antenna 21, the fourth antenna 22, the fifth antenna 23, and the sixth antenna 24, so as to generate another group of virtual array whose distributions are identical to that of the third antenna 21, the fourth antenna 22, the fifth antenna 23, and the sixth antenna 24, but is translated by 2N times the distance of the unit interval d (equal to the interval between the first antenna 11 and the second antenna 12) with respect to the third antenna 21. Finally, the two arrays above are combined to form the equivalent antenna array 40 shown in the lower part of FIG. 2.

Notably, the angle resolution of the regular ULA antenna array is decided according to the aperture of the antenna array. Therefore, if the angle resolution of the antenna array is to be increased, the number of antennas has to be increased, thereby increasing the whole antenna array. However, an ordinary hardware has a fixed size, which is unable to hold infinite numbers of antennas. Therefore, a longer equivalent antenna array 40 is able to be obtained through the combination of physical and virtual antennas, so as to increase the aperture of the antenna array, thereby increasing the angle resolution.

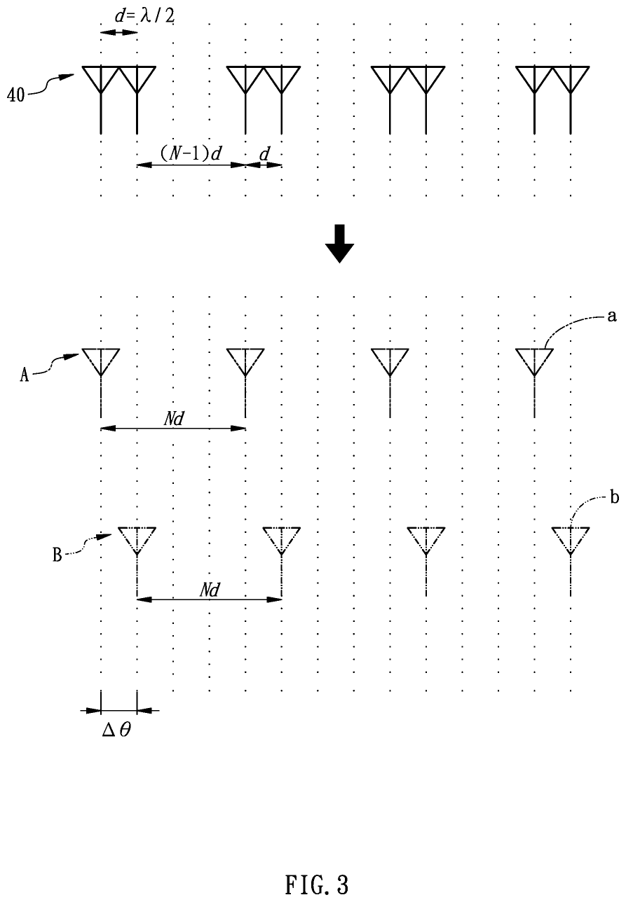

Also as shown by FIG. 3, the equivalent antenna array 40 is allowed to be divided to and includes a first equivalent antenna group A and a second equivalent antenna group B. The first equivalent antenna group A comprises a plurality of first antenna units a arranged at equal intervals, and the second equivalent antenna B comprises a plurality of second antenna units b arranged at equal intervals.

In the embodiment, the second equivalent antenna group B is translated by a unit interval d with respect to the first equivalent antenna group A, so that each first antenna unit a and each second antenna unit b are staggered and arranged at equal intervals along the same direction. In the embodiment, the interval between each two neighboring first antenna units a and the interval between each two neighboring second antenna units b are N times the unit interval d. With such configuration, the original equivalent antenna array 40 is divided into two ULA arrays, namely the first equivalent antenna group A and the second equivalent antenna group B.

Through the equivalent antenna array 40 obtained from the combination of the first physical antenna array 10 and the second physical antenna array 20, the processor 30 obtains a target signal 31 reflected by the target object.

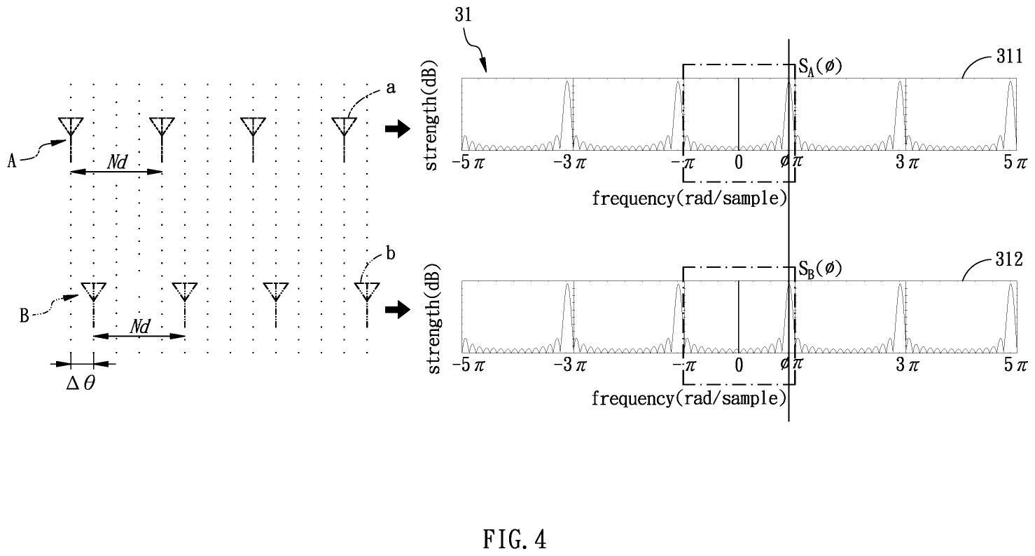

Referring to FIG. 3 to FIG. 4, the processor 30 processes the target signal 31 to generate a first frequency spectrum information 311 and a second frequency spectrum information 312 under the frequency domain, wherein the horizontal axis of the first frequency spectrum information 311 and the second frequency spectrum information 312 is the frequency (rad/sample), and the longitudinal axis thereof is the strength (dB). The first frequency spectrum information 311 is from the frequency spectrum variation of the first equivalent antenna group A, and the second frequency spectrum information 312 is from the frequency spectrum variation of the second equivalent antenna group B. According to the first frequency spectrum information 311 and the second frequency spectrum information 312, the processor 30 carries out a calibration and calculation to obtain a precise phase difference, thereby further obtaining an accurate angle of arrival through the precise phase difference.

Furthermore, the processor 30 comprises a calibration model 32 and a precise phase model 33. The processor 30 inputs an ambiguous phase obtained from the first frequency spectrum information 311 and the second frequency spectrum information 312 into the calibration model 32 to obtain a calibrated value and further inputs the calibrated value into the precise phase model 33 to obtain the precise phase difference.

For further information, the calibration model 32 is shown as the following formula:

$$k = round \{ [ ( N * ∠ \frac{{S}_{B} ( ϕ )}{{S}_{A} ( ϕ )} ) - ϕ ] / 2 π \} ,$$

wherein, “k” represents the calibrated value, “round” represents the function rounded to the nearest integer, “N” represents the multiple of the unit interval d, “ϕ” represents the initial phase variation quantity of the target object detected by the first equivalent antenna group A and the second equivalent antenna group B “S_{A}(ϕ)” represents the signal strength of the first equivalent antenna group A, “S_{B}(ϕ)” represents the signal strength of the second equivalent antenna group B, and “

$$∠ \frac{{S}_{B} ( ϕ )}{{S}_{A} ( ϕ )}$$

” represents the ambiguous phase difference.

The precise phase model 33 is shown as the following formula:

Δθ=(ϕ+2kπ)/N, wherein “Δθ” represents the precise phase difference.

In the embodiment, the first frequency spectrum information 311 comprises the phase variation quantity ϕ and the signal strength S_{A}(ϕ), the second frequency spectrum information 312 comprises the phase variation quantity ϕ and the signal strength S_{B}(ϕ). Notably, because the phase variation quantity obtained by the first equivalent antenna group A and the second equivalent antenna group B correspond to the identical target object, the phase variation quantity ϕ of them shall be identical as well.

After obtaining the signal strength S_{A}(ϕ) and signal strength S_{B}(ϕ), the processor carries out the calculation of the formula

$$∠ \frac{{S}_{B} ( ϕ )}{{S}_{A} ( ϕ )}$$

to obtain the ambiguous phase difference and then inputs the ambiguous phase difference into the calibration model 32 to obtain the calibrated value k. Next, the processor 30 inputs the calibrated value k into the precise phase model 33 to obtain the precise phase difference Δθ.

Notably, when under the ideal circumstances without noise interference, the ambiguous phase difference and the precise phase difference Δθ shall be identical. However, in practical situation, the phase difference calculated from the signal strength S_{A}(ϕ) and the signal strength S_{B}(ϕ) includes the noise, so that the precise phase difference is unable to be obtained under the possible effect thereof. Therein, if a calculation of

$$[ ( N * ∠ \frac{{S}_{B} ( ϕ )}{{S}_{A} ( ϕ )} ) - ϕ ] / 2 π$$

is directly carried out to obtain k, the obtained k will not be an integer. However, the k has to practically be a positive integer. Therefore, through the processing of the calibration model 32, the k is able to be obtained as an integer, and such calibrated value k is used for subsequent process.

Besides, because the interval between each first antenna unit a of the first equivalent antenna group A and the interval between each second antenna unit b of the second equivalent antenna group B are larger than or equal to ½λ, the object beyond the detection range of the antenna angle will have the same performance as the object within the angle range. In other words, the phase variation quantity ϕ obtained from the first frequency spectrum information 311 and the second frequency spectrum information 312 shall actually be ϕ+2kπ, causing the ambiguity of the phase variation quantity ϕ. Therefore, through the processing of the precise phase model 33, the precise phase difference Δθ is obtained.

For example, the angle of arrive of the target object is 46 degrees, and the multiple N of the unit interval d is 4. The processor 30 firstly obtains the ambiguous phase difference

$$∠ \frac{{S}_{B} ( ϕ )}{{S}_{A} ( ϕ )} = 0.7632 π$$

from the first frequency spectrum information 311 and the second frequency spectrum information 312. Due to the effect of noise, the ambiguous phase difference is inputted into asind

$$( ∠ \frac{{S}_{B} ( ϕ )}{{S}_{A} ( ϕ )} )$$

to obtain an inaccurate angle of arrival as 49.7471 degrees. Therefore, the processor 30 inputs the ambiguous phase difference into the calibration model 32

$$k = round \{ [ ( N * ∠ \frac{{S}_{B} ( ϕ )}{{S}_{A} ( ϕ )} ) - ϕ ] / 2 π \} ,$$

obtaining the calibrated value k=1. Then, the calibrated value k in inputted into the precise phase model 33 Δθ=(ϕ+2kπ)/N, obtaining the precise phase difference Δθ=0.71887π. Finally, the processor 30 inputs the precise phase difference Δθ into arcsind(Δθ), obtaining an accurate angle of arrival as 45.9555 degrees, which is more accurate compared to the angle of arrival obtain with the ambiguous phase difference.

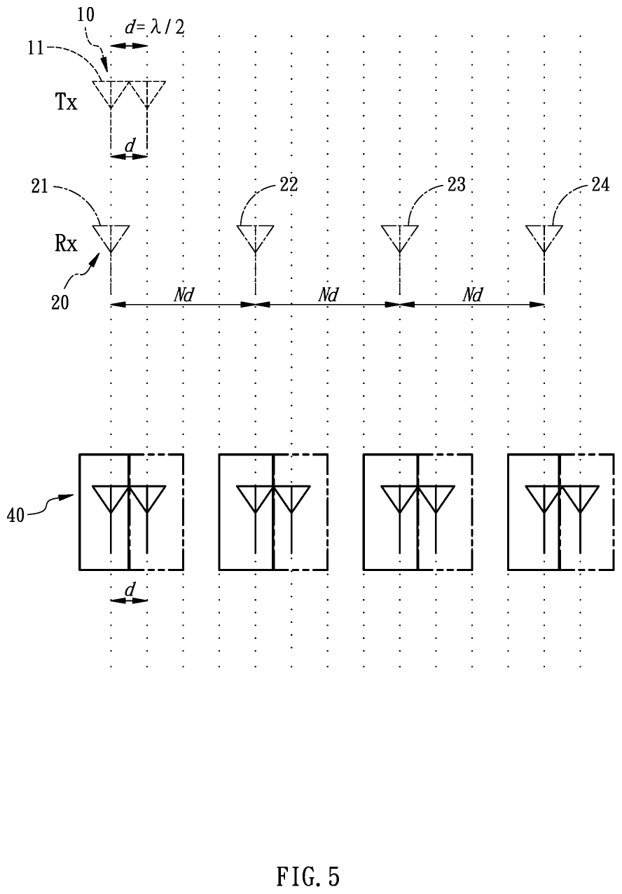

Referring to FIG. 5, which is a schematic view of the physical antenna array in accordance with the second embodiment of the present invention, the difference between the second embodiment and the first embodiment lies in the arrangement distribution. However, both distributions are able to form the same equivalent antenna array 40.

In this embodiment, the interval between the first antenna 11 and the second antenna 12 is the unit interval d. The interval between the third antenna 21, the fourth antenna 22, the fifth antenna 23, and the sixth antenna 24 are N times the unit interval d. Therein, the unit interval d is larger than or equal to ½λ, and λ is the wavelength of the transmission signal. N is a positive integer, and N is larger than or equal to 3, In this embodiment, N is equal to 4.

In this embodiment, the first physical antenna array 10 is the transmission antenna, and the second physical antenna array 20 is the receiving antenna. However, the configuration is allowed to be exchanged, such that the first physical antenna array 10 is the receiving antenna, and the second physical antenna array 20 is the transmission antenna. In this embodiment, the equivalent antenna array 40 is allowed to be a physical antenna or a combination of a physical antenna and a virtual antenna. Also, the first physical antenna array 10 is allowed to be extended multiple times at equal intervals, so as to include four antennas or six antennas, etc. Similarly, the second physical antenna array 20 is allowed to be extended multiple times at equal intervals, so as to include eight antennas or twelve antennas, etc.

Further, in this embodiment, the equivalent antenna array 40 is formed of following configuration. The first antenna 11 is multiplied by the third antenna 21, the fourth antenna 22, the fifth antenna 23, and the sixth antenna 24, so as to generate an array whose positions and distributions are identical to that of the third antenna 21, the fourth antenna 22, the fifth antenna 23, and the sixth antenna 24. Then, the second antenna 12 is multiplied by the third antenna 21, the fourth antenna 22, the fifth antenna 23, and the sixth antenna 24, so as to generate another group of virtual array whose distributions are identical to that of the third antenna 21, the fourth antenna 22, the fifth antenna 23, and the sixth antenna 24, but is translated by the distance of the unit interval d (equal to the interval between the first antenna 11 and the second antenna 12) with respect to the third antenna 21. Finally, the two arrays above are combined to form the equivalent antenna array 40.

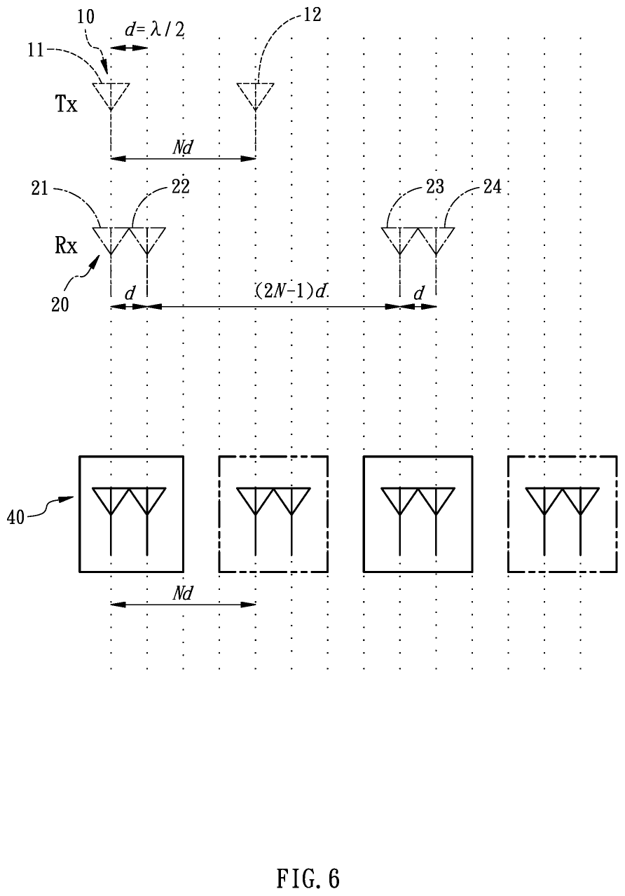

Referring to FIG. 6, which is a schematic view of the physical antenna array in accordance with the third embodiment of the present invention, the difference between the third embodiment and the first and second embodiments lies in the arrangement distribution. However, those distributions are all able to form the same equivalent antenna array 40.

In this embodiment, the interval between the first antenna 11 and the second antenna 12 is N times the unit interval d. The interval between the third antenna 21 and the fourth antenna 22 is the unit interval d. The interval between fourth antenna 22 and the fifth antenna 23 is (2N-1) times the unit interval d. The interval between the fifth antenna 23 and the sixth antenna 24 is the unit interval d. Therein, the unit interval d is larger than or equal to ½λ, and λ is the wavelength of the transmission signal. N is a positive integer, and N is larger than or equal to 3. In this embodiment, N is equal to 4.

In this embodiment, the first physical antenna array 10 is the transmission antenna, and the second physical antenna array 20 is the receiving antenna. However, the configuration is allowed to be exchanged, such that the first physical antenna array 10 is the receiving antenna, and the second physical antenna array 20 is the transmission antenna. In this embodiment, the equivalent antenna array 40 is allowed to be a physical antenna or a combination of a physical antenna and a virtual antenna. Also, the first physical antenna array 10 is allowed to be extended multiple times at equal intervals, so as to include four antennas or six antennas, etc. Similarly, the second physical antenna array 20 is allowed to be extended multiple times at equal intervals, so as to include eight antennas or twelve antennas, etc.

Further, in this embodiment, the equivalent antenna array 40 is formed of following configuration, the first antenna 11 is multiplied by the third antenna 21, the fourth antenna 22, the fifth antenna 23, and the sixth antenna 24, so as to generate an array whose positions and distributions are identical to that of the third antenna 21, the fourth antenna 22, the fifth antenna 23, and the sixth antenna 24. Then, the second antenna 12 is multiplied by the third antenna 21, the fourth antenna 22, the fifth antenna 23, and the sixth antenna 24, so as to generate another group of virtual array whose distributions are identical to that of the third antenna 21, the fourth antenna 22, the fifth antenna 23, and the sixth antenna 24, but is translated by N times the distance of the unit interval d (equal to the interval between the first antenna 11 and the second antenna 12) with respect to the third antenna 21. Finally, the two arrays above are combined to form the equivalent antenna array 40.

The aforementioned embodiments mainly explain that the physical antenna array is allowed to have different arrangement distributions, and all structures capable of forming the equivalent antenna structure in accordance with the present invention fall into the equivalent scope of the claims of the present invention.

With the foregoing configuration, effects and functions of the present invention will be illustrated below.

Through the equivalent antenna array 40 obtained from the distribution design of the first physical antenna array 10 and the second physical antenna array 20, the present invention is able to increase the length of the antenna array under the condition of a limited number of the antenna units, so as to increase the aperture of the antenna array, thereby increasing the angle resolution of antenna.

Also, through the calibration model 32 and the precise phase model 33 of the processor 30, the first frequency spectrum information 311 and the second frequency spectrum information 322 from the equivalent antenna array 40 are calculated to generate the precise phase difference, so that the present invention prevents the issue of angle ambiguity when the interval between the antenna units is larger than half wavelength, thereby obtaining the accurate angle of arrival of the target signal 31.

Although particular embodiments of the invention have been described in detail for purposes of illustration, various modifications and enhancements may be made without departing from the spirit and scope of the invention. Accordingly, the invention is not to be limited except as by the appended claims.

1. A high-resolution antenna array for detecting an angle and a distance of at least one target object, the antenna array system comprising:
a first physical antenna array comprising at least one first physical antenna;
a second physical antenna array comprising a plurality of second physical antennas, the first physical antenna array and the second physical antenna array being configured to detect the target object, then transmit and receive signal;
an equivalent antenna array obtained by multiplying positions of the first physical antenna array by positions of the second antenna array, the equivalent antenna array comprising a first equivalent antenna group having a plurality of first antenna units arranged at equal intervals and a second equivalent antenna group having a plurality of second antenna units arranged at equal intervals, wherein the second equivalent antenna group is translated by a unit interval with respect to the first equivalent antenna group, such that each first antenna unit and each second antenna unit are staggered and arranged at intervals along a same direction, an interval between each two neighboring first antenna units and an interval between each two neighboring second antenna units are N times the unit interval, wherein N is a positive integer, and N is larger than or equal to 3; and
a processor coupled with the first physical antenna array and the second physical antenna array, through which the processor obtains a target signal reflected by the target object, the target signal being from the first equivalent antenna group and the second equivalent antenna group, the processor carrying out a calibration on the target signal to obtain an accurate angle of arrival.

2. The high-resolution antenna array of claim 1, wherein the target signal comprises a first frequency spectrum information from the first equivalent antenna group and a second frequency spectrum information from the second equivalent antenna group; the processor carries out a calibration according to the first frequency spectrum information and the second frequency spectrum information to obtain a precise phase difference, thereby further obtaining the accurate angle of arrival through the precise phase difference.

3. The high-resolution antenna array of claim 2, wherein the processor comprises a calibration model and a precise phase model; the processor firstly inputs an ambiguous phase difference obtained from the first frequency spectrum information and the second frequency spectrum information into the calibration model to obtain a calibrated value, and further inputs the calibrated value into the precise phase model to obtain the precise phase difference.

4. The high-resolution antenna array of claim 3, wherein the calibration model is presented as
$$k = round \{ [ ( N * ∠ \frac{{S}_{B} ( ϕ )}{{S}_{A} ( ϕ )} ) - ϕ ] / 2 π \} ,$$
k represents the calibrated value, round represents a function rounded to a nearest integer, ϕ represents an initial phase variation quantity of the target object detected by the first equivalent antenna group and the second equivalent antenna group, S_{A}(ϕ) represents a signal strength of the first equivalent antenna group, S_{B}(ϕ) represents a signal strength of the second equivalent antenna group, and
$$∠ \frac{{S}_{B} ( ϕ )}{{S}_{A} ( ϕ )}$$
represents the ambiguous phase difference.

5. The high-resolution antenna array of claim 4, wherein the precise phase model is presented as Δθ=(ϕ+2kπ)/N; the processor inputs the calibrated value k into the precise phase model, so as to obtain the precise phase difference Δθ.

6. The high-resolution antenna array of claim 4, wherein the first frequency spectrum information comprises the phase variation quantity ϕ and the signal strength S_{A}(ϕ); the second frequency spectrum information comprises the phase variation quantity ϕ and the signal strength S_{B}(ϕ).

7. The high-resolution antenna array of claim 1, wherein the unit interval is larger than or equal to ½λ, and λ is a wavelength of the transmission signal.

8. A high-resolution antenna array for detecting an angle and a distance of at least one target object, the antenna array comprising:
a first physical antenna array comprising a first antenna and a second antenna, an interval between the first antenna and the second antenna being 2N times a unit interval, N being a positive integer, and N being larger than or equal to 3;
a second physical antenna array comprising a third antenna, a fourth antenna, a fifth antenna, and a sixth antenna orderly arranged along a same direction, an interval between the third antenna and the fourth antenna being the unit interval, an interval between the fourth antenna and the fifth antenna being (N-1) times the unit interval, an interval between the fifth antenna and the sixth antenna being the unit interval, wherein the first physical antenna array and the second physical antenna array are configured to detect the target object, transmit and receive signal, and obtain a target signal from the target object; and
a processor coupled with the first physical antenna array and the second physical antenna array, the processor obtaining an equivalent antenna array by multiplying positions of the first physical antenna array by positions of the second physical antenna array, so as to obtain the target signal through the equivalent antenna array, and the processor carrying out a calibration on the target signal to obtain an accurate angle of arrival.

9. A high-resolution antenna array for detecting an angle and a distance of at least one target object, the antenna array comprising:
a first physical antenna array comprising a first antenna and a second antenna, an interval between the first antenna and the second antenna being a unit interval;
a second physical antenna array comprising a third antenna, a fourth antenna, a fifth antenna, and a sixth antenna orderly arranged along a same direction at equal intervals, an interval between the third antenna, the fourth antenna, the fifth antenna, and the sixth antenna being N times the unit interval, N being a positive integer, and N being larger than or equal to 3, wherein the first physical antenna array and the second physical antenna array are configured to detect the target object, transmit and receive signal, and obtain a target signal from the target object; and
a processor coupled with the first physical antenna array and the second physical antenna array, the processor obtaining an equivalent antenna array by multiplying positions of the first physical antenna array by positions of the second physical antenna array, so as to obtain the target signal through the equivalent antenna array, and the processor carrying out a calibration on the target signal to obtain an accurate angle of arrival.

10. A high-resolution antenna array for detecting an angle and a distance of at least one target object, the antenna array comprising:
a first physical antenna array comprising a first antenna and a second antenna, an interval between the first antenna and the second antenna being N times a unit interval, N being a positive integer, and N being larger than or equal to 3;
a second physical antenna array comprising a third antenna, a fourth antenna, a fifth antenna, and a sixth antenna orderly arranged along a same direction, an interval between the third antenna and the fourth antenna being the unit interval, an interval between the fourth antenna and the fifth antenna being (2N-1) times the unit interval, an interval between the fifth antenna and the sixth antenna being the unit interval, wherein the first physical antenna array and the second physical antenna array are configured to detect the target object, transmit and receive signal, and obtain a target signal from the target object; and
a processor coupled with the first physical antenna array and the second physical antenna array, the processor obtaining an equivalent antenna array by multiplying positions of the first physical antenna array by positions of the second physical antenna array, so as to obtain the target signal through the equivalent antenna array, and the processor carrying out a calibration on the target signal to obtain an accurate angle of arrival.

11. The high-resolution antenna array of anyone from claims 8 to 10, wherein the equivalent antenna array comprises a first equivalent antenna group having a plurality of first antenna units arranged at equal intervals and a second equivalent antenna group having a plurality of second antenna units arranged at equal intervals; the target signal comprises a first frequency spectrum information from the first equivalent antenna group and a second frequency spectrum information from the second equivalent antenna group; the processor carries out a calibration according to the first frequency spectrum information and the second frequency spectrum information to obtain a precise phase difference, thereby further obtaining the accurate angle of arrival through the precise phase difference.

12. The high-resolution antenna array of claim 11, wherein the processor comprises a calibration model and a precise phase model; the processor firstly inputs an ambiguous phase difference obtained from the first frequency spectrum information and the second frequency spectrum information into the calibration model to obtain a calibrated value, and further inputs the calibrated value into the precise phase model to obtain the precise phase difference.

13. The high-resolution antenna array of claim 12, wherein the calibration model is presented as
$$k = round \{ [ ( N * ∠ \frac{{S}_{B} ( ϕ )}{{S}_{A} ( ϕ )} ) - ϕ ] / 2 π \} ,$$
k represents the calibrated value, round represents a function rounded to a nearest integer, ϕ represents an initial phase variation quantity of the target object detected by the first equivalent antenna group and the second equivalent antenna group, S_{A}(ϕ) represents a signal strength of the first equivalent antenna group, S_{B}(ϕ) represents a signal strength of the second equivalent antenna group, and
$$∠ \frac{{S}_{B} ( ϕ )}{{S}_{A} ( ϕ )}$$
represents the ambiguous phase difference.

14. The high-resolution antenna array of claim 13, wherein the precise phase model is presented as Δθ=(ϕ+2kπ)/N; the processor inputs the calibrated value k into the precise phase model, so as to obtain the precise phase difference Δθ.

15. The high-resolution antenna array of claim 13, wherein the first frequency spectrum information comprises the phase variation quantity ϕ and the signal strength S_{A}(ϕ); the second frequency spectrum information comprises the phase variation quantity ϕ and the signal strength S_{B}(ϕ).

16. The high-resolution antenna array of claim 11, wherein the unit interval is larger than or equal to ½λ, and λ is a wavelength of the transmission signal.

17-18. (canceled)
